(19) United States
(12) Patent Application Publication
(10) Pub. No.: US 2007/0085368 A1
(43) Pub. Date: Apr. 19, 2007

(54) Vehicle body structure of vehicle including seat

(75) Inventors: Masato Hirokawa, Hiroshima (JP); Yoh Koizumi, Hiroshima (JP); Kenji Satani, Hiroshima (JP); Masao Hara, Hiroshima (JP); Yusuke Kohge, Hiroshima (JP); Shigeaki Watanabe, Hiroshima (JP); Gunji Yoshii, Hiroshima (JP); Kazuhiro Matsuhashi, Hiroshima (JP); Keisuke Iida, Hiroshima (JP); Masaki Nishino, Hiroshima (JP); Masato Shimada, Hiroshima (JP); Yoshitaka Fujihara, Hiroshima (JP); Hiromasa Honji, Hiroshima (JP); Yuji Ohta, Hiroshima (JP); Hiroshi Okiyama, Hiroshima (JP); Tsutomu Naganuma, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/508,193

(22) Filed: Aug. 23, 2006

(30) Foreign Application Priority Data
Sep. 30, 2005 (JP) 2005-287781

(51) Int. Cl. B60N 2/20

(52) U.S. Cl. 296/65.16

(57) ABSTRACT

A vehicle body structure of a vehicle including a seat, having a baggage compartment at a rear portion in a cabin, comprises a seat back supported by a hinge member provided at a lower portion of the seat so as to rotate in a longitudinal direction, the seat back being provided to be held in a specified upright position, a first engagement portion provided at an outside end portion of the seat back, a second engagement portion provided at a portion of a vehicle sidewall portion corresponding to the first engagement portion, wherein the first and second engagement portions are configured to be fixed in a vehicle width direction when the seat back is in the specified upright position. Thereby, a rigidity of the vehicle body can be improved by using the seat back.

### BACKGROUND OF THE INVENTION

The present invention relates to a vehicle body structure of a vehicle including a seat, particularly including the seat whose seat back is held in a specified upright state.

It is known that a vehicle such as an automotive vehicle includes a foldable seat whose seat back can be rotated (inclined) to provide a useful space at a vehicle rear portion. Particularly, this foldable seat has been used widely in a so-called one-box type of vehicle that uses its rear space as a baggage compartment to provide a wider baggage space in it.

Herein, a structure of a striker being provided at a vehicle sidewall portion to hold the seat back of the foldable seat is also known. The seat back of the foldable seat can be held in the specified upright position by this structure of the striker.

Japanese Patent Application Laid-Open No. 11-263247 discloses a seat-back attaching structure. in which there is provided a reinforcing member comprising a cross member and upright members, which are provided at a vehicle floor portion and vehicle sidewall portions, and a rear seat back is attached so as to be enclosed by this reinforcing member.

Herein, a vehicle such as the one-box type of vehicle has no member behind a rearmost row seat that extends in a vehicle width direction and separates the baggage space from a cabin space, unlike a sedan type of vehicle. Accordingly, some countermeasures for securing a sufficient rigidity at the vehicle rear portion against any vibrations or the like that may occur at the vehicle body have been required.

### SUMMARY OF THE INVENTION

The present invention has been devised in view of the above-described problem, and an object of the present invention is to provide a vehicle body structure of a vehicle including a seat that can improve the vehicle body rigidity properly by using a seat back of the seat.

According to the present invention, there is provided a vehicle body structure of a vehicle including a seat, in which a baggage compartment is provided at a rear portion in a cabin and the seat is provided in the cabin, comprising a seat back of the seat, the seat back being supported by a hinge member provided at a lower portion of the seat so as to rotate in a longitudinal direction, the seat back being provided to be held in a specified upright position, a first engagement portion that is provided at an outside end portion of the seat back, a second engagement portion that is provided at a portion of a vehicle sidewall portion corresponding to the first engagement portion so as to engage with the first engagement portion, wherein the first and second engagement portions are configured to be fixed in a vehicle width direction when the seat back is in the specified upright position.

According to the present invention, since the seat can be fixed to the vehicle body surely, vibrations, stresses, or shaking that would occur at the vehicle body can be transferred to the seat back, so the rigidity of the vehicle body can be improved properly by using the seat back. Since the seat back in the specified upright position is fixed in the vehicle width direction, it can be prevented from being moved improperly in the vehicle width direction by the vibrations or the like.

According to an embodiment of the present invention, there are provided a striker provided at the vehicle sidewall portion and a latch provided at the seat back so as to engage with the striker, and the seat back is held in the specified upright position by engagement of the striker and latch. Thereby, the seat back can be held in the specified upright position surely and the effect of the present invention described above can be attained properly. Since a relatively small striker is provided at the vehicle sidewall portion, a wider space can be provided in the cabin when the seat back is inclined (rotated) forward or the like.

According to another embodiment of the present invention, the striker comprises a lateral connecting portion that extends inside from the vehicle sidewall portion, and the latch includes a first hook and a second hook that are operative to engage with the lateral connecting portion together vertically. Thereby, since the latch is configured to engage with the striker vertically (in a vertical direction of the vehicle), a length of the striker extending inside can be made shorter. Thus, there can be provided a much wider space in the cabin when the seat back is inclined (rotated) forward or the like.

According to another embodiment of the present invention, a distance between the first engagement portion and the hinge member is shorter than that between the latch and the hinge member. Thereby, since the first and second engagement portions can engage with each other in an accurate position state, a secure engagement of these portions can be attained along with the engagement of the striker and the latch.

According to another embodiment of the present invention, a wheel house is provided at the vehicle sidewall portion so as to project inside, and the second engagement portion is provided above or near the wheel house. Thereby, since the second engagement portion can be disposed so as to be hidden by the wheel house, better appearances can be provided.

According to another embodiment of the present invention, the seat comprises a plurality of independent seat backs that are disposed side by side in the vehicle width direction, and there is provided a seat-back connecting device operative to interconnect adjacent seat backs. Thereby, since the seat backs disposed side by side can be interconnected, the vehicle-body rigidity can be further improved.

Other features, aspects, and advantages of the present invention will become apparent from the following description which refers to the accompanying drawings.

### BRIEF DESCRIPTION OF THE DRAWINGS

FIG. 1 is a perspective view schematically showing a vehicle rear body of a vehicle according to the present embodiment.

FIG. 2 is an explanatory sectional view taken along line Y2-Y2 of FIG. 1.

FIG. 3 is a partially-enlarged perspective view of the vehicle rear body, when viewed from a vehicle rear.

FIG. 4 is a partially-enlarged perspective view of the vehicle rear body, when viewed from a vehicle front.

FIG. 5 is an explanatory elevation view of part of a seat back.

FIG. 6 is an explanatory sectional view taken along line Y6-Y6 of FIG. 1.

FIG. 7 is an explanatory elevation view of a latch.

FIG. 8 is an explanatory elevation view of a second engagement portion, which is a partially-enlarged view of a support member.

FIG. 9 is an explanatory diagram schematically showing an enlarged A portion of a seat shown in FIG. 1.

FIG. 10 is a perspective view of a right-side connecting member provided at a right-side seat back.

### DETAILED DESCRIPTION OF THE INVENTION

Hereinafter, a preferred embodiment of the present invention will be described referring to the accompanying drawings.

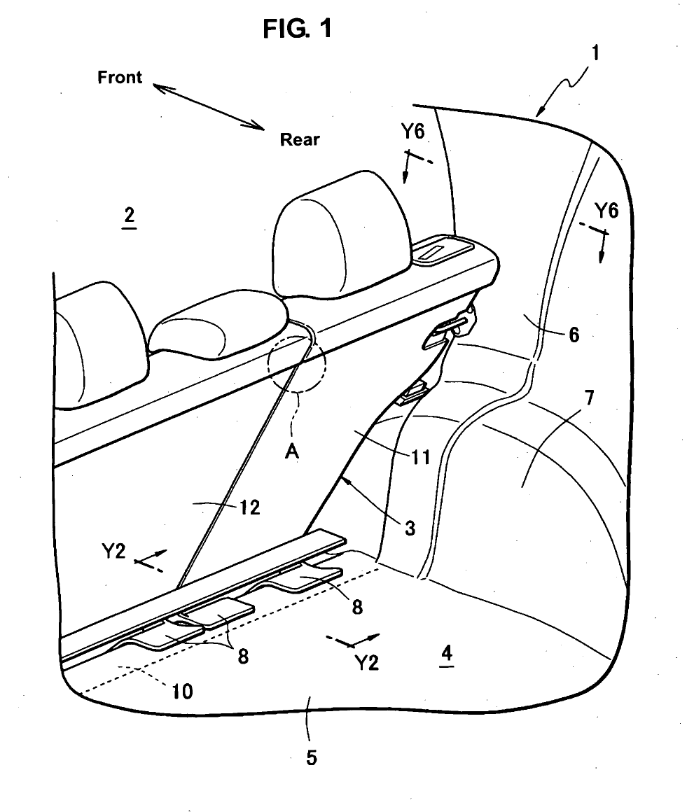

FIG. 1 is a perspective view schematically showing a vehicle rear body of a vehicle according to the present embodiment. A vehicle 1 is, for example, a so-called one box type of vehicle, a baggage compartment 4 is provided in back of a seat 3 that is disposed in a vehicle cabin 2. The vehicle rear body of the vehicle 1, as apparent from FIG. 1, comprises a vehicle floor portion 5 to form a floor face of the vehicle and a vehicle sidewall portion 6 to form a side face of the vehicle body.

A wheel house 7 is provided at a vehicle sidewall portion 6 so as to project toward the inside of the vehicle 1, and the seat 3 is disposed on the vehicle floor portion 5 via a hinge member 8. The hinge member 8 is connected to a cross member 10 extending in a vehicle width direction. A seat back of the seat 3 comprises a right-side seat back 11 and a left-side seat back 12. Hereinafter, the right-side seat back 11 will be described mainly.

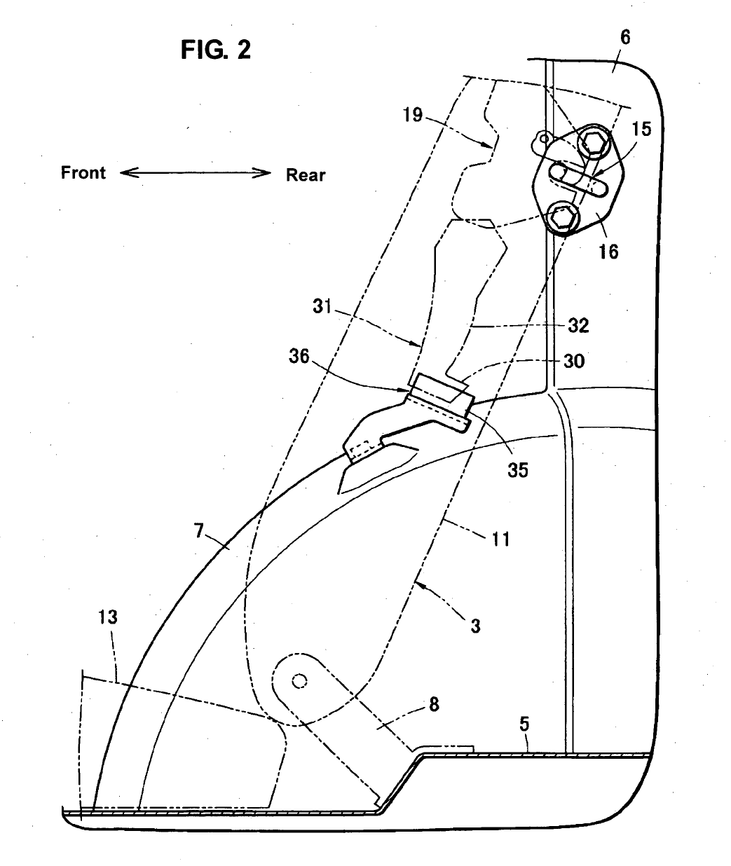

FIG. 2 is an explanatory sectional view taken along line Y2-Y2 of FIG. 1. Herein, the seat 3, other parts and the hinge member 8 are shown by two-dotted broken lines in order to show the vehicle sidewall portion 6 apparently.

The seat 3 comprises a seat cushion 13 and the seat back 11, and the seat back 11 is supported by the hinge member 8 so as to rotate in a longitudinal direction of the vehicle and be biased forward by a coil spring disposed at the hinge member 8. Herein, the hinge member 8 may be disposed below the seat 3 with a different type.

The seat back 11 can take a specified upright position as shown in FIGS. 1 and 2. In the present embodiment, the seat back 11 is disposed with an inclined angle of 10-20 degrees relative to a vertical direction. In this upright position, the seat back 11 is supported by the hinge member 8 and an outside end portion of the seat back 11 is supported at the vehicle sidewall portion 6.

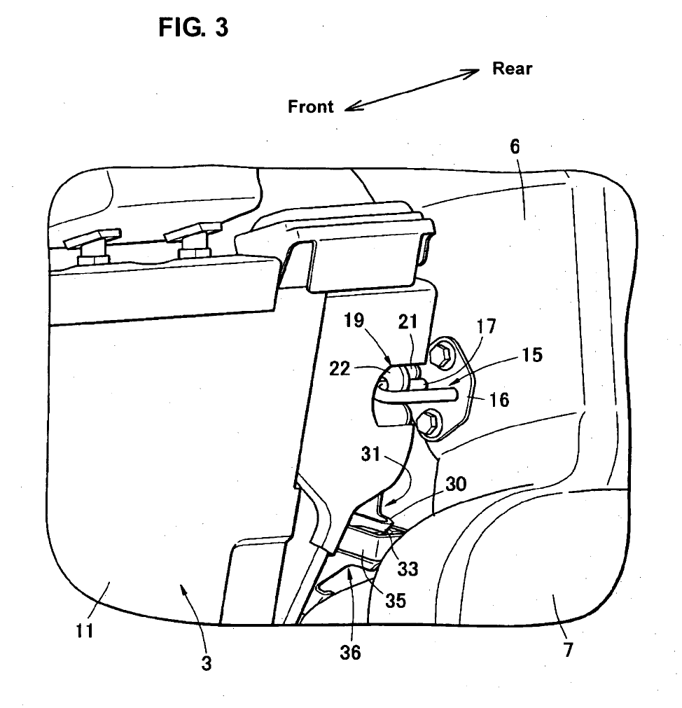

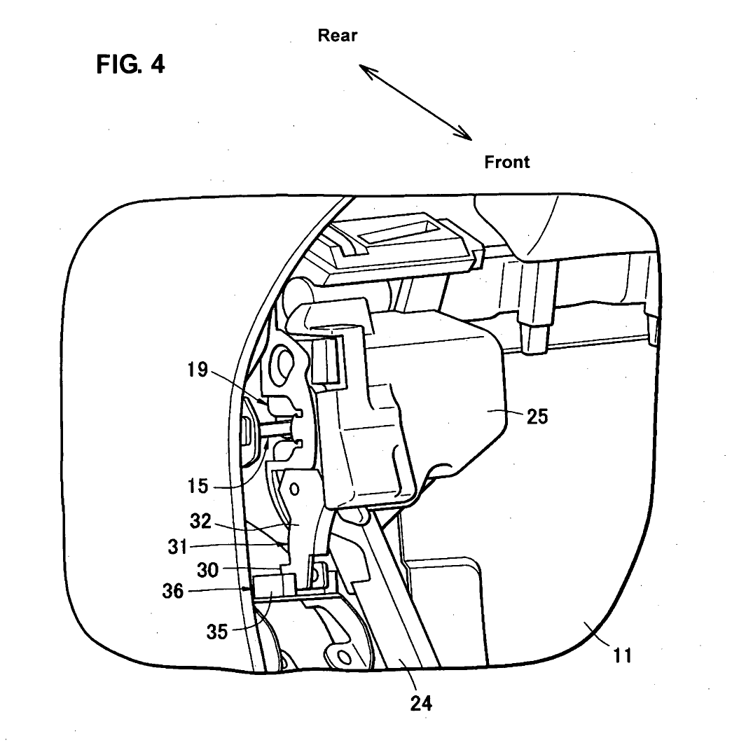

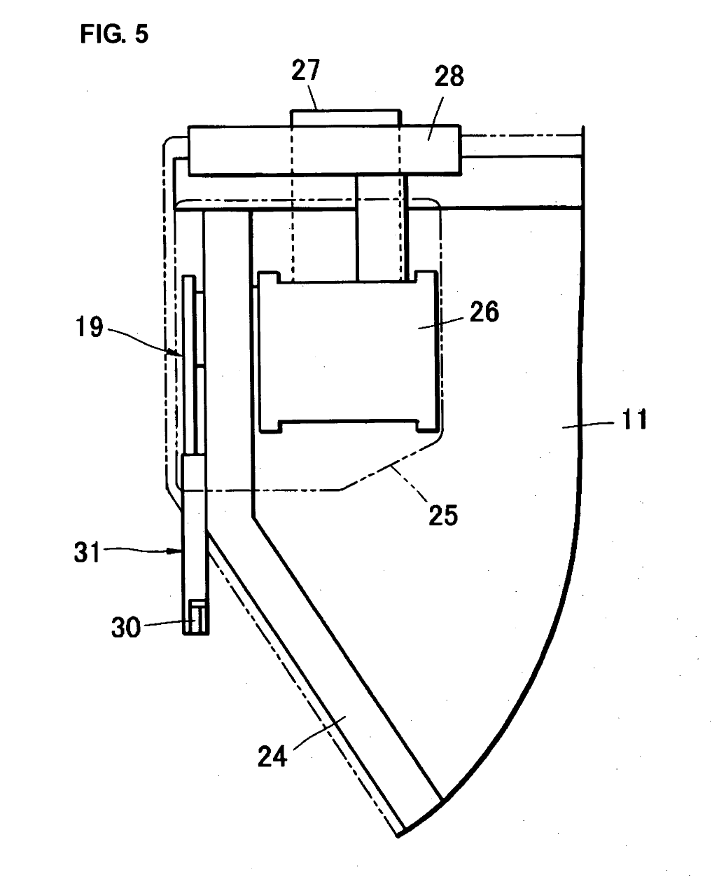

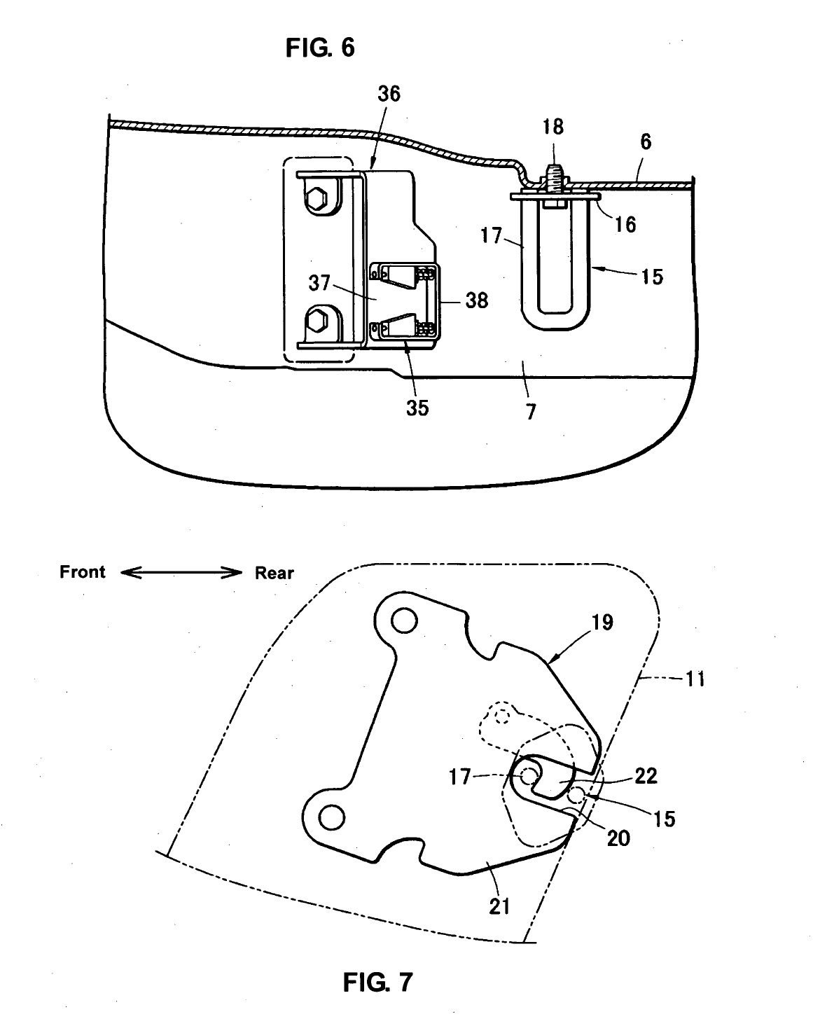

FIG. 3 is a partially-enlarged perspective view of the vehicle rear body, when viewed from a vehicle rear, FIG. 4 is a partially-enlarged perspective view of the vehicle rear body, when viewed from a vehicle front, and FIG. 5 is an explanatory elevation view of part of the seat back. Herein, these figures illustrate a state in which covering members are removed from the seat back 11. FIG. 6 is an explanatory sectional view taken along line Y6-Y6 of FIG. 1, which illustrates a state in which the seat 3 is removed.

As shown in FIG. 3, a striker 15 is provided at the vehicle sidewall portion 6 above the wheel house 7, and the outside end portion of the seat back 11 that is in the specified upright position is supported at the vehicle sidewall portion 6 via the striker 15. An elevation view of the striker 15 is illustrated in FIG. 2 and a side view of the striker 15 is illustrated in FIG. 6.

The striker 15 is formed in a substantially U shape, and its both ends are connected to a striker attaching portion 16 that is formed in a substantially flat-plate shape. The striker 15 includes a lateral connecting portion 17 that extends from the striker attaching portion 16 at a substantially right angle. The striker attaching portion 16 is attached to the vehicle sidewall portion 6 via fastening bolts 18 in such a manner that the lateral connecting portion 17 of the striker 15 extends from the vehicle sidewall portion 6 in the vehicle width direction.

Meanwhile, a latch 9 is provided at the outside end portion of the seat back 11. FIG. 7 is an elevation view of the latch. Herein, the seat back 11 and the striker 15 are illustrated by two-dotted broken lines. The latch 19 is disposed so as to open rearward, and comprises a first hook portion 21 that includes a slot portion 20 to receive the above-described lateral connecting portion 17 of the striker 15 and a second hook portion 22 that is coupled to the first hook portion 21 and selectively engages with the lateral connecting portion 17 of the striker 15.

These hook portions 21, 22 are formed in the substantially flat-plate shape and disposed longitudinally at the outside end portion of the seat back 11, respectively. The latch 19 with the first and second hook portions 21, 22 is attached via a panel-shaped attaching bracket 25 to a seat back frame 24 that is provided in a rectangular shape or a reverse-U shape, when viewed from the front, so as to enclose an outer peripheral portion of the seat back 11, as shown in FIGS. 4 and 5. Herein, as shown in FIG. 5, a retractor 26 is provided at the attaching bracket 25, and a seatbelt 27 is provided so as to be withdrawn forward from the retractor 26 through a withdrawal portion 28.

The seat back 11, which is always biased forward, is allowed to rotate from the front to the rear, and it can be held in the specified upright position by engagement of the latch 19 with the striker 15 provided at the vehicle sidewall portion 6, specifically by the first and second hook portions 21, 22 engaging with the lateral connecting portion 17 together vertically. Herein, the striker 15 is formed to be relatively small compared to the latch 19 as shown in FIG. 2.

In the present embodiment, as shown in FIG. 3, the seat back 11 has a wedge member 31 including a first engagement portion 30 that extends rearward, which is attached at the outside end portion of the seat back 11. And, there is provided a support member 36 including a second engagement portion 35 above the wheel house 7. The second engagement portion 35 is configured to engage with the first engagement portion 30.

The above-described wedge member 31 comprises a wedge bracket 32 that is attached to the seat back frame 24 so as to extend vertically, and at a lower end of the wedge bracket 32 is provided the first engagement portion 30 having a U-shaped cross section. This first engagement portion 30, which is made of a resilient material such as rubber, is disposed such that its curve portion 33 having a U-shaped cross section projects rearward.

The wedge member 31 is provided below the latch 19 at the outside end portion of the seat back 11. Namely, the wedge member 31 is located such that a distance between the wedge member 31 and the hinge member 8 is shorter than that between the latch 19 and the hinge member 8.

Meanwhile, the support member 36 is attached to a forward portion on the wheel house 7. The second engagement portion 35 of the support member 36, as shown in FIG. 6, is attached to an inside portion on the wheel house 7 and includes an opening portion 37 at the front and a wall portion 38 having a substantially U-shaped cross section.

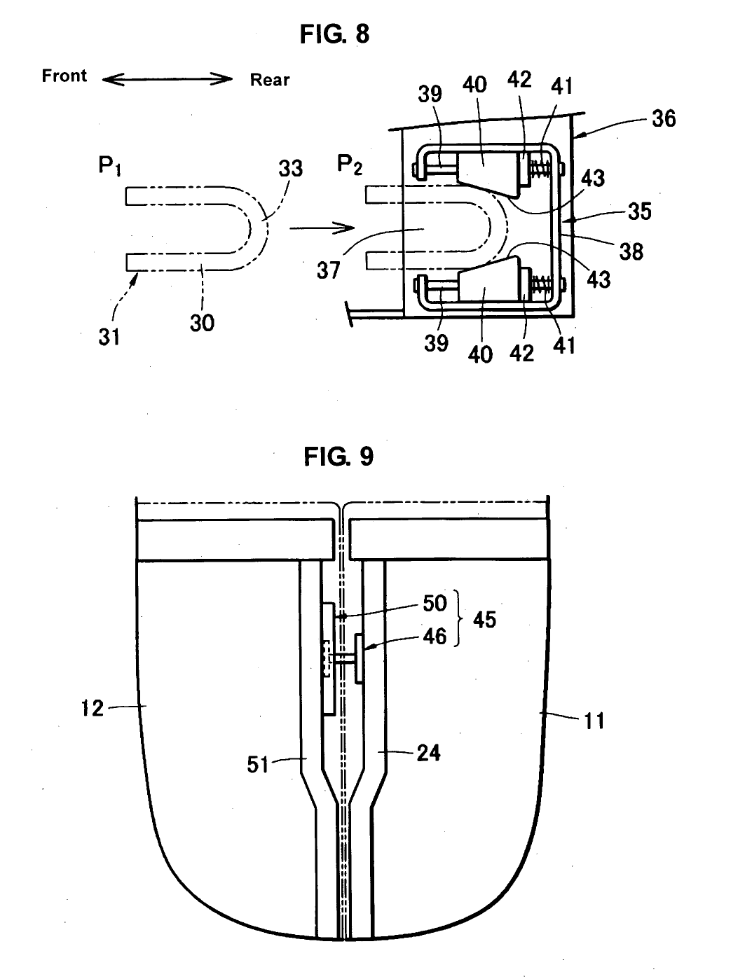

FIG. 8 is an explanatory elevation view of the second engagement portion, which is a partially-enlarged view of the support member. Herein, the first engagement portion 30 of the wedge member 31 is illustrated by a two-dotted broken line. At both end portions of the wall portion 38 of the second engagement portion 35 are respectively provided rod-shaped axis members 39 extending longitudinally, and respective both ends of the axis members 39 are supported at the wall portion 38.

Each of the axis members 39 comprises an engaging member 40, a spring member 41 to bias the engagement member 40 forward, and a plate member 42 that is provided between these members 40, 41. The two engaging members 40, which are disposed to face each other, are made of a resilient material such as rubber, and have taper-shaped end faces 43 that are disposed in such a manner that their front ends open widely.

When the seat back 11 is in the specified upright position, the first engagement portion 30 provided at the seat back 11 moves from P1 position to P2 position, as shown in FIG. 8, and the curve portion 33 of the first engagement portion 30 is supported by the taper-shaped end faces 43 of the second engagement portion 35. In this way, the first engagement portion 30 pushes the engaging members 40 rearward against the spring force, so the first engagement portion 30 is fixed in the vehicle width direction by the second engagement portion 35.

The first engagement portion 30 is configured to have the U-shaped cross section and the second engagement portion 35 is configured to have taper-shaped end faces 43 in the present embodiment. However, any other modifications of the first and second engagement portions 30, 35 can be applied such that the seat back 11 in the upright position and the vehicle sidewall portion 6 can be fixed in the vehicle width direction. For example, a wedge-shaped member may be applied so that its front end with taper faces can contact the end faces 43 of the engaging member 40.

Also, although the second engagement portion 35 is provided on the wheel house 7 in the present embodiment, it may be provided near the wheel house 7. The left-side seat back 12 has the same structure at its outside end portion as the right-side seat back 11 described above.

According to the vehicle body structure of a vehicle including the seat of the present embodiment, since the seat 3 can be fixed to the vehicle body surely, vibrations, stresses or shaking that would occur at the vehicle body can be transferred to the seat back with the structure in which there are provided the first engagement portion 30 provided at the outside end portion of the seat back 11 and the second engagement portion 35 provided at the portion of the vehicle sidewall portion 6 corresponding to the first engagement portion 30, and these engagement portions 30, 35 are configured to be fixed in the vehicle width direction when the seat back 11 is in the specified upright position. Thereby, the rigidity of the vehicle body can be improved properly by using the seat back. Since the seat back 11 in the specified upright position is fixed in the vehicle width direction, it can be prevented from being moved improperly in the vehicle width direction by the vibrations or the like.

Also, since there are provided the striker 15 provided at the vehicle sidewall portion 6 and the latch 19 provided at the seat back so as to engage with the striker 15, and the seat back 11 is held in the specified upright position by engagement of the striker 15 and latch 19, the seat back can be held in the specified upright position surely and the above-described effect can be attained properly. Since the relatively small striker 15 is provided at the vehicle sidewall portion 6, a wider space can be provided in the cabin when the seat back is inclined forward or the like.

Further, since the latch 19 includes the first hook 21 and the second hook 22 that are operative to engage with the lateral connecting portion 17 of the striker 15 together vertically, the length of the striker extending inside can be made shorter. Thus, there can be provided the much wider space in the cabin when the seat back is inclined forward or the like.

And, since the distance between the first engagement portion 30 and the hinge member 8 is shorter than that between the latch 19 and the hinge member 8, the first and second engagement portions can engage with each other in an accurate position state. Thus, a secure engagement of these portions can be attained along with the engagement of the striker and the latch.

Also, since the wheel house 7 is provided at the vehicle sidewall portion 6 so as to project inside and the second engagement portion 35 is provided above or near the wheel house 7, the second engagement portion can be disposed so as to be hidden by the wheel house, and thus better appearances can be provided.

Also, as described above, the seat 3 comprises the right-side seat back 11 and the left-side seat back 12 that are separate from each other. FIG. 9 is an explanatory diagram schematically showing an enlarged A portion of a seat shown in FIG. 1. Herein, FIG. 9 illustrates a state in which covering members are removed from the right and left seat backs 11, 12.

A seat-back connecting device 45 to interconnect the both seat backs 11, 12 is shown in FIG. 9. As described above, the seat back frame 24 is provided at an outer peripheral portion of the right-side seat back 11, and a right-side connecting member 46 is provided at an inside end portion of the seat back frame 24.

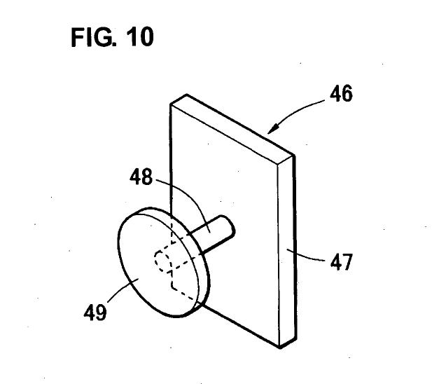

FIG. 10 is a perspective view of the right-side connecting member provided at the right-side seat back. The right-side connecting member 46 comprises a right-side connecting-member attaching portion 47 formed in flat-plate shape, a connecting rod portion 48 projecting from the attaching portion 47 at a right angle, and a disc-shaped hat portion 49 provided at a tip of the portion 48. The right-side connecting-member attaching portion 47 is attached to an upper portion of the inside end portion of the seat back frame 24.

Meanwhile, at the left-side seat back 12 is provided a left-side connecting member 50 operative to engage with the right-side connecting member 46 provided at the right-side seat back 11. The left-side connecting member 50 is attached to the seat back frame 51 provided at an outer peripheral portion of the left-side seat back 12, which can engage with the connecting rod portion 48 of the right-side connecting member 46.

Although the seat-back connecting device 45 comprised of the connecting members 46, 50 interconnects the both seat backs 11, 12 via the connecting rod portion 48 in the longitudinal direction in the present embodiment, it may be configured to interconnect them in the vehicle width direction like the wedge member 31 and the support member 36.

Although the seat back 3 comprises two independent seat back, the right-side seat back 11 and the left-side seat back 12, in the present embodiment, it may comprise more seat backs or these right and left seat backs may be formed integrally.

As described above, since the seat 3 comprises a plurality of independent seat backs 11, 12 that are disposed side by side in the vehicle width direction and there is provided the seat-back connecting device 45 operative to interconnect adjacent seat backs 11, 12, the seat backs disposed side by side can be interconnected, and thereby the vehicle-body rigidity can be further improved.

The present invention should not limited to the above-described embodiment, and any other modifications and improvements may be applied within the scope of a sprit of the present invention. For example, although the present invention is applied to the one-box type of vehicle in the present embodiment, it is also applicable to any other types of vehicle in which the seat back of the seat can engage with the vehicle sidewall portion.

What is claimed is:

1. A vehicle body structure of a vehicle including a seat, in which a baggage compartment is provided at a rear portion in a cabin and the seat is provided in the cabin, comprising:
a seat back of the seat, the seat back being supported by a hinge member provided at a lower portion of the seat so as to rotate in a longitudinal direction, the seat back being provided to be held in a specified upright position;
a first engagement portion that is provided at an outside end portion of said seat back;
a second engagement portion that is provided at a portion of a vehicle sidewall portion corresponding to said first engagement portion so as to engage with the first engagement portion,
wherein said first and second engagement portions are configured to be fixed in a vehicle width direction when the seat back is in the specified upright position.

2. The vehicle body structure of a vehicle including a seat of claim 1, wherein there are provided a striker provided at the vehicle sidewall portion and a latch provided at said seat back so as to engage with the striker, and said seat back is held in the specified upright position by engagement of said striker and latch.

3. The vehicle body structure of a vehicle including a seat of claim 2, wherein said striker comprises a lateral connecting portion that extends inside from the vehicle sidewall portion, and said latch includes a first hook and a second hook that are operative to engage with said lateral connecting portion together vertically.

4. The vehicle body structure of a vehicle including a seat of claim 2, wherein a distance between said first engagement portion and said hinge member is shorter than that between said latch and the hinge member.

5. The vehicle body structure of a vehicle including a seat of claim 1, wherein a wheel house is provided at the vehicle sidewall portion so as to project inside, and said second engagement portion is provided above or near the wheel house.

6. The vehicle body structure of a vehicle including a seat of claim 1, wherein the seat comprises a plurality of independent seat backs that are disposed side by side in the vehicle width direction, and there is provided a seat-back connecting device operative to interconnect adjacent seat backs.
